(19) United States
(12) Patent Application Publication
(10) Pub. No.: US 2002/0011503 A1
(43) Pub. Date: Jan. 31, 2002

(54) Baby carrier

(76) Inventor: Choon H. Hwang, Anyang (KR)

Correspondence Address: Park & Sutton LLP, Suite 1110, 3255 Wilshire Blvd., Los Angeles, CA, 90010, US

(21) Appl. No.: 09/910,529

(22) Filed: Jul. 20, 2001

(30) Foreign Application Priority Data
Jul. 21, 2000 (KR) 2000-0041864

(51) Int. Cl. A61G 1/00; A45F 3/04

(52) U.S. Cl. 224/160; 224/638; 224/652

(57) ABSTRACT

A baby carrier is provided, which includes: a baby wrapper having a back supporter formed toward the back of a user, a bottom sheet formed on the bottom of the back supporter and a sheet formed by folding the back supporter and the bottom sheet in the counter-direction of the user's back, to thereby form a space for enabling the user to take a baby on the user's back; a reception portion having a sack formed to have a reception space in the direction where the back supporter is folded from the baby wrapper; shoulder straps formed toward either shoulder of the user from the sack of the reception portion; and a supporter which is connected toward each other in the middle of the shoulder straps, and connected with the shoulder straps from the center portion on the bottom of the baby wrapper.

### CLAIMING FOREIGN PRIORITY

The applicant claims and requests a foreign priority, through the Paris Convention for the Protection of Industry Property, based on a patent application filed in the Republic of Korea (South Korea) with the filing date of Jul. 21, 2000, with the patent application number 2000-0041864, by the applicant. (See the Attached Declaration)

### BACKGROUND OF THE INVENTION

1. Field of the Invention

The present invention relates to a baby carrier, and more particularly, to a baby carrier which enables a baby to be taken on a baby caretaker's back such as a baby mother's back at the posture of the baby sitting on a chair, to thereby reduce burdens of the baby caretaker such as the mother of the baby.

2. Description of the Related Art

In general, most of baby carriers which are used for taking a baby on a baby caretaker's back includes a cover sheet wrapping both bodies of a baby and a baby caretaker, and a binding strap wound round the cover sheet, for providing a binding force for binding the cover sheet.

Such a conventional baby carrier enables a baby caretaker to take a baby on his or her back comfortably with a comparatively small force, since the baby adheres to the baby caretaker. However, since the baby enclosed with the cover sheet is bound on the baby caretaker's waist with the binding strap in use, it is not convenient for the baby caretaker to use the baby carrier. Further, the baby can fall down from the baby caretaker's back at an instant time when the baby is taken on the baby caretaker's back.

A baby carrier shown in FIG. 1 and disclosed in Korean Patent Laid-open Publication No. 99-73529 includes a wrapper 10 capable of enclosing a baby, a hip supporting belt (not shown) whose both ends are combined with the wrapper 10, to thereby support the hip of the baby, and shoulder belts 30 which are respectively provided on both ends of the wrapper 10, and which are bound mutually by a binder 31. In particular, the wrapper 10 includes an elastic supporter 11 for elastically supporting the neck of the baby to smoothly support the neck of the baby. Also, a saddle pants portion 12 having flexibility is provided in the inner surface of the wrapper 10 so that the baby can be stably supported.

However, in the case of the above conventional baby carrier, the weight of the baby is concentrated into the hip support belt, and the saddle pants portion presses over the thighs and the waist of the baby, to thereby have the baby feel uncomfortable. Further, when the baby is inserted into the saddle pants portion, the legs of the baby should be widened. In addition, a variety of articles to be carried basically by a baby caretaker should be carried separately.

Korean patent laid-open publication Nos. 97-61142 and 99-1143, disclose a technology entitled “Waist bag combined with baby holder,” respectively in which a baby is sat in the body of a baby holder combined with a waist bag, and simultaneously a simple article can be accommodated.

However, in the case of the “waist bag combined with baby holder,” since a baby caretaker is somewhat distant from a baby, the baby caretaker should burden a heavy workload. Also, since the baby caretaker should always embrace a baby, the baby caretaker is easy to be tired when he or she is out or works for a long time. Further, since the weight of the baby is concentrated on the inside of the thighs of the baby, the baby may feel uncomfortable.

### SUMMARY OF THE INVENTION

To solve the above problems, it is an object of the present invention to provide a baby carrier that is designed to reduce the burden of the weight of a baby.

It is another object of the present invention to provide a baby carrier that enables a baby to sit therein psychologically stable and comfortably due to a structure that a baby adheres closely to a baby caretaker.

It is still another object of the present invention to provide a baby carrier that can be used as a knapsack when the baby carrier is not used for taking a baby on a baby caretaker's back, and simple articles can be accommodated even when the baby carrier is used for taking a baby on a baby caretaker's back.

To accomplish the above object of the present invention, there is provided a baby carrier comprising: a baby wrapper having a back supporter in which the back of a baby is supported, a bottom sheet extended from the back supporter and in which the hip of the baby contacts, and auxiliary supporters each connected to the bottom sheet, for supporting the thighs of the baby; and shoulder straps for mutually connecting the back supporter and the auxiliary supporters and hooking the mutually connected straps on the shoulders of a baby caretaker.

Connection belts for connecting the shoulder straps mutually are formed in the middle of the shoulder straps. Safety belts connected to the shoulder straps are sewed around the lower-center of the baby wrapper.

A sack and an auxiliary pocket each having a reception space are additionally formed in the back supporter of the baby wrapper.

The auxiliary supporters are connected by gap adjustment straps so that a gap with respect to the back supporter or the bottom sheet can be adjusted.

### BRIEF DESCRIPTION OF THE DRAWINGS

The above objects and other advantages of the present invention will become more apparent by describing the preferred embodiments thereof in more detail with reference to the accompanying drawings in which:

FIG. 1 is a perspective view showing a conventional baby carrier;

FIG. 2A is a perspective view showing a baby carrier according to the present invention;

FIG. 2B is a bottom view showing a baby carrier according to the present invention;

FIG. 3 is a rear view showing the baby carrier shown in FIGS. 2A and 2B;

FIG. 4A is a side view showing the unfolded state of the baby carrier according to the present invention;

FIG. 4B is a side view showing the folded state of the baby carrier according to the present invention;

FIG. 5 schematically shows the state of using the baby carrier shown in FIG. 2;

FIG. 6 schematically shows a distribution state of the baby's weight during use of the baby carrier shown in FIG. 5;

FIG. 7 is a schematically perspective view showing a baby carrier according to another embodiment of the present invention; and

FIG. 8 schematically shows the state of using the baby carrier shown in FIG. 7.

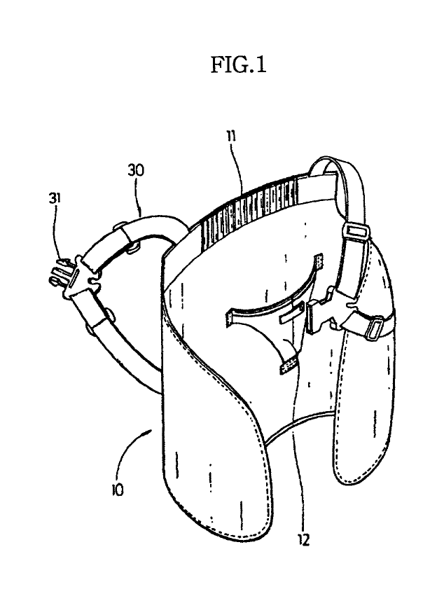

### DETAILED DESCRIPTION OF THE INVENTION

Preferred embodiments of the present invention will be described with reference to the accompanying drawings.

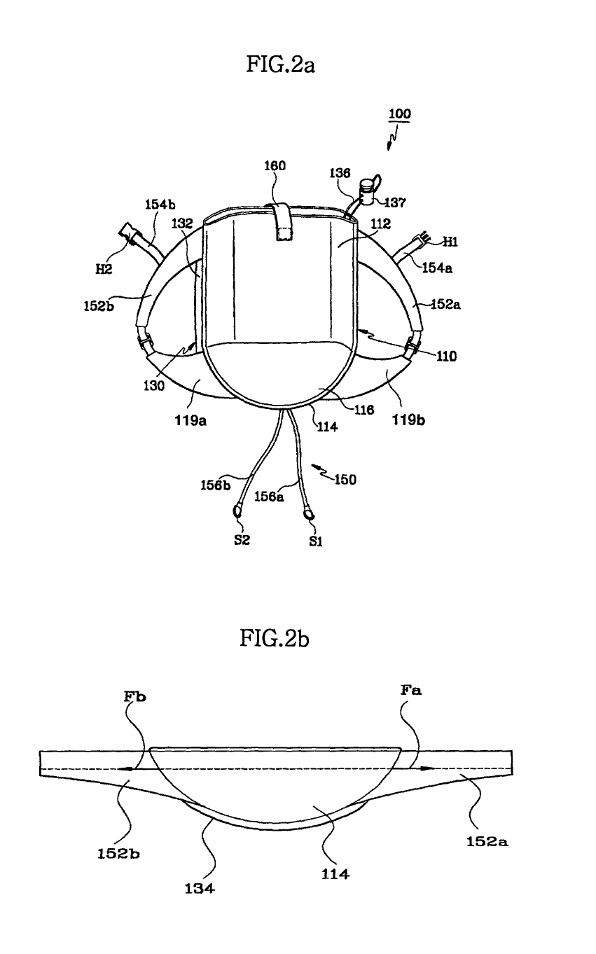

Referring to FIG. 2, a baby carrier 100 according to the present invention includes a baby wrapper 110 having a back supporter 112 in which the back of a baby is supported to have the baby feel comfortable as if the baby sits on a chair, a sheet 116 extended from the back supporter 112 so that the hip of the baby contacts, and auxiliary supporters 119a and 119b connected to the sheet 116, for supporting the thighs of the baby. Also, the baby carrier includes a reception portion 130 which can accommodate nursing bottles and diapers, and supporters 150 for maintaining a baby to be stable at the state where a baby is taken on a baby caretaker's back.

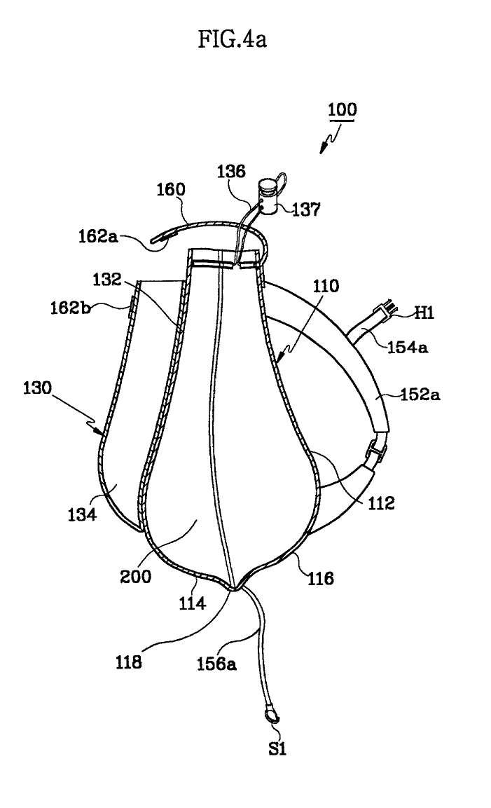

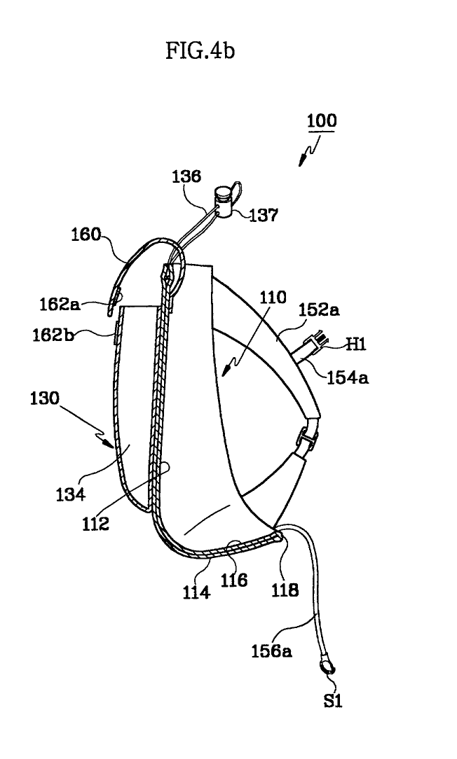

As shown in FIG. 4B, the baby carrier 100 becomes a state where a baby can be taken on a baby caretaker's back in the case that the baby wrapper 110 is folded into the reception portion 130. However, as shown in FIG. 4A, in the case that the baby carrier is not used for caretaking a baby, the baby wrapper 110 is unfolded from the reception portion 130, so that the baby carrier 100 becomes a state where articles can be contained in the reception portion 130.

The back supporter 112 is formed in the baby wrapper 110, and the bottom sheet 114 is formed in the lower portion of the back supporter 112. The back supporter 112 and the bottom sheet 114 form a space where a baby can sit therein. At the portion where the bottom sheet 114 is folded are provided the sheet 116 for supporting the hip of the baby and the auxiliary supporters 119a and 119b for supporting the thighs of the baby.

The reception portion 130 includes a sack 132 forming a reception space together with the back supporter 112 of the baby wrapper 110. The sack 132 further includes one or more auxiliary pockets 134.

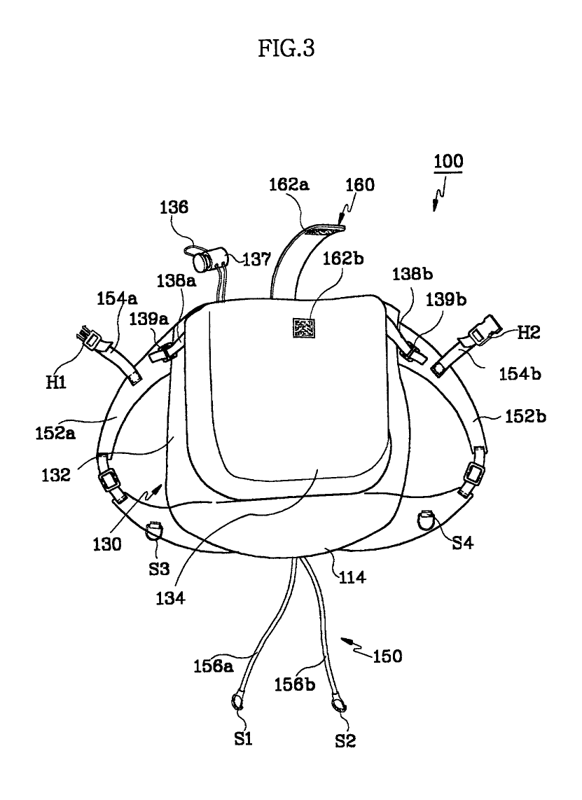

The supporter 150 includes safety belts 156a and 156b which are sewed on the bottom sheet 114. Hooks S1 and S2 are formed in the respective ends of the safety belts 156a and 156b, which are respectively connected to rings S3 and S4 (see FIG. 3) provided in shoulder straps 152a and 152b.

In the case of connection belts 154a and 154b, a male holder H1 is formed in each one end thereof and a female holder H2 is formed in the other end thereof. Accordingly, the connection belts 154a and 154b are respectively connected to the shoulder straps 152a and 152b. In this case, the shoulder straps 152a and 152b are prevented from slipping down from either shoulder of the baby caretaker.

Meanwhile, as shown in FIG. 2B, the shoulder straps 152a and 152b are preferably constituted in the same directions as those of forces Fa and Fb working in the transverse direction with respect to the bottom sheet 114 when a baby caretaker takes a baby on his or her back. In this case, since the weight of the baby is distributed on the bottom sheet 114 uniformly, a baby caretaker feels a relatively small burden during the time when he or she takes a baby on his or her back.

FIG. 3 is a rear view showing the baby carrier shown in FIGS. 2A, which shows a sack 132 and an auxiliary pocket 134 in the reception portion 130.

A tightening strap 136 is provided in the upper side of the sack 132. An adjustment unit 137 is connected to the tightening strap 136. Thus, when the tightening strap 136 is tightened or released, the opening of the reception portion can be opened and closed.

Also, the auxiliary pocket 134 is formed separately from the sack 132 with a relatively small size in the external middle of the sack 132. The auxiliary pocket 134 plays a role of containing nursing bottles or diapers during the time when a baby caretaker is out while taking a baby on his or her back with the baby wrapper 110.

Also, adjustment belts 138a and 138b are provided in the auxiliary pocket 134 and connected with adjustment strips 139a and 139b formed in the shoulder straps 152a and 152b. In this case, the adjustment belts 138a and 138b can be adjusted in length and the baby wrapper 110 can also be adjusted depending upon the body shape of a baby. Accordingly, in the case that a baby is taken on a baby caretaker's back, the baby can adhere mutually more closely to the baby caretaker.

A hook-shaped magic tape 162a is attached on a belt 160 sewed in the upper-center of the back supporter 112, and a loop-shaped magic tape 162b is attached on the auxiliary pocket 134 to which the hook-shaped magic tape 162a is attached.

Referring to FIG. 4A, the baby carrier 100 of the unfolded state enables the back supporter 112 of the baby wrapper 110 is inflated externally, to thereby further widen the reception space 200 in the reception portion 130. Thus, the sheet 116 in the baby wrapper 110 is unfolded around a folding line 118 formed on the bottom sheet 114 as soon as the back supporter 112 is inflated, to then form a plane integrated with the bottom sheet 114. In this case, since articles can be accommodated in the reception space 200 formed in the sack 132 of the reception portion 130, the baby carrier can be used as a knapsack.

Referring to FIG. 4B, the baby carrier 100 of the folded state constitutes a state where the sheet 116 folded toward the reception space 200 in the reception portion 130 around the folding line 118 together with the bottom sheet 114, in which case a baby can sit on the sheet 116.

A border is formed on the edge of the sheet 116 by the folding line 118. The sheet 116 is lengthened due to the weight of the baby, to thereby form a catenary curve, which distributes the load of the baby and supports the thighs of the baby.

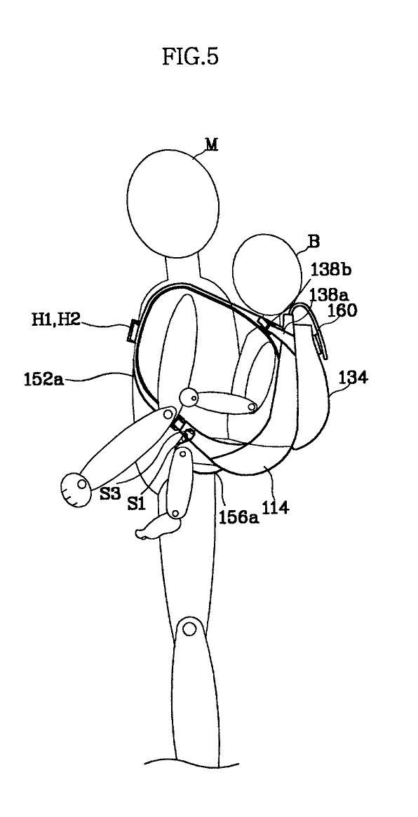

Referring to FIG. 5 schematically showing the use state of the baby carrier, a baby B is sat on the back supporter 112 and the sheet 116 of the baby wrapper 110. The connection belts 154a and 154b go across the chest of a baby's caretaker M and mutually connect both the shoulder straps 152a and 152b by a male holder H1 and a female holder H2 so that the shoulder straps 152a and 152b are prevented from slipping down from the shoulders of the baby caretaker. Also, the safety belts 156a and 156b in the supporter 150 pass through between the legs of the baby and hooks S1 and S2 in the safety belts 156a ad 156b are combined with rings S3 and S4 provided on the shoulder straps 152a and 152b, to thereby prevent the baby B from falling down from the baby carrier.

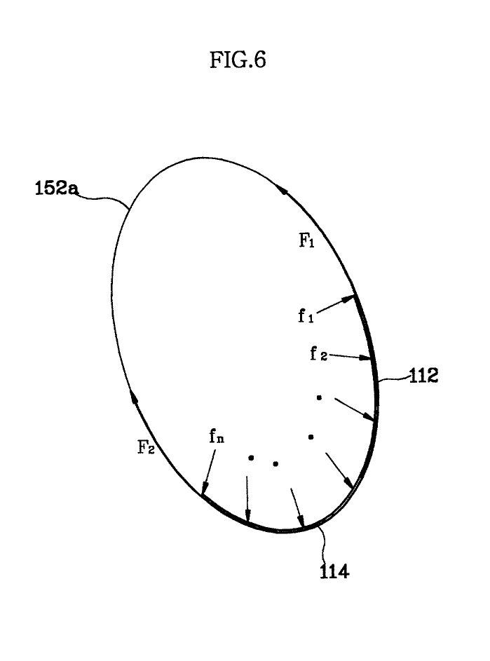

FIG. 6 schematically shows a distribution state of the baby's weight during use of the baby carrier shown in FIG. 5.

In the case that the baby's caretaker M wears a baby carrier, the weight of the baby B works on the wide curve of the back supporter 112 and the bottom sheet 114. The loads indicated by f1, f2, . . . , and fn of the baby B are transferred to the shoulder strap 152a as the external forces F1 and F2. As a result, an equilibrium state is maintained and enables the baby B to closely adhere to the baby caretaker M. As the baby B closely adheres to the baby caretaker M, a distance between the load center of the baby B and the baby caretaker M is short. Accordingly, since a coupling moment become small, external forces F1 and F2 burdened by the baby caretaker M become small. Thus, since a much smaller force is consumed during the time when the baby caretaker M works after caretaking the baby B, the fatigue of the baby caretaker M is reduced. Also, since the baby B adheres to the baby caretaker M, the baby B becomes psychologically stable.

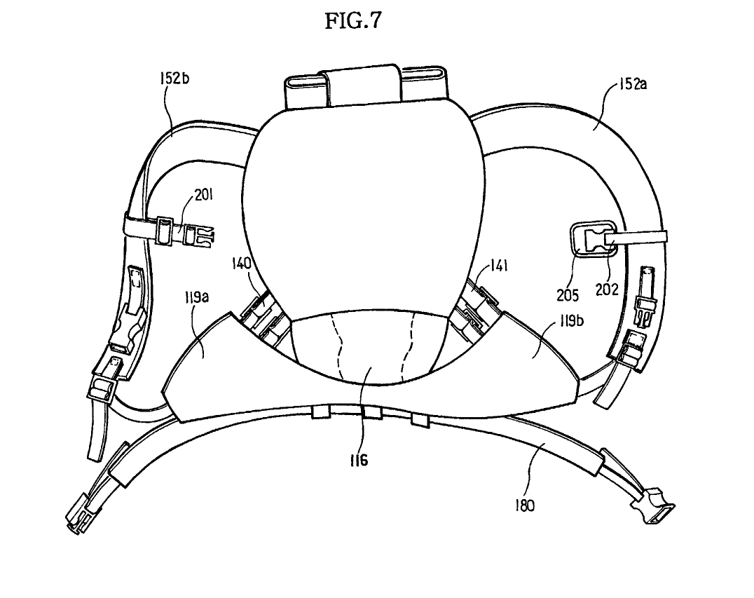

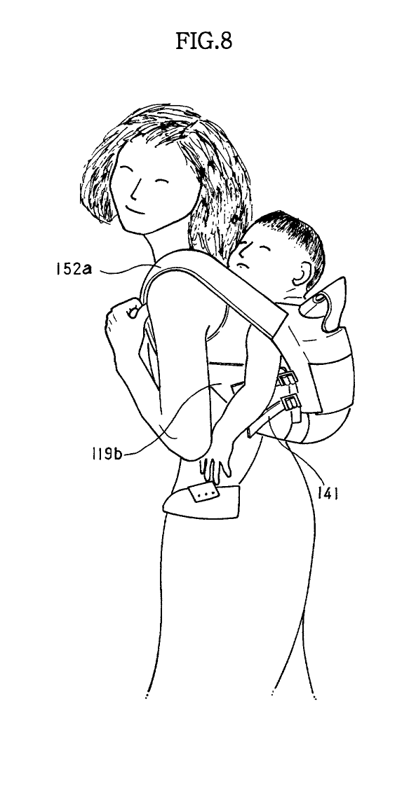

Meanwhile, referring to FIGS. 7 and 8 showing another embodiment of the present invention, a baby carrier includes a sheet 116 which has a concave structure into which a baby can be loaded.

Also, auxiliary supporters 119a and 119b are sewed on each one edge of the sheet 116 so that the thighs of the baby can be supported. The other edges of the auxiliary supporters 119a and 119b and the sheet 116 are connected with adjustment straps 140 and 141 so that the gap between the auxiliary supporters 119a and 119b and the sheet 116 can be adjusted mutually. In this case, the adjustment straps 140 and 141 can be adjusted according to the body shape of the baby.

Also, a waist belt 180 is connected to the auxiliary supporters 119a and 119b. The waist belt 180 is worn on the waist of the baby caretaker to prevent movement of the baby carrier. Accordingly, the baby caretaker can be freely at work even when he or she wears the baby carrier.

Reference numerals 201 and 202 denote connection belts having the same functions as those of the connection belts 154a and 154b in the previous embodiment. The connection belts 201 and 202 are connected to shoulder straps 152a and 152b, to thereby prevent the shoulder straps 152a and 152b from slipping down from the shoulders of the baby caretaker.

Reference numeral 205 denotes a protector for preventing a pressure when hooks of the connection belts 201 and 202 contact the body of the baby caretaker.

The present invention is not limited to the above embodiments. It is apparent to those who are skilled in the art that there are many modifications within the technical scope and spirit of the invention.

As described above, the bay carrier according to the present invention has the following merits and advantages.

First, at the state when a baby is strapped to a baby caretaker's back, the tensile strength works on the sheet and the back supporter by the shoulder straps and the weight of the baby, to thereby form a catenary curve in the sheet and the back supporter. Thus, the weight of the baby is distributed uniformly, and the baby adheres closely to the baby caretaker's back. As a result, a coupling moment occurring when the baby caretaker is at work becomes smaller, which enables the baby caretaker to consume a much smaller amount of force and burden when he or she takes the baby on his or her back.

Second, the structure that the baby adheres closely to the baby caretaker's back provides the baby with a sense of psychological stability.

Third, the baby carrier can be used as a knapsack when the baby carrier is not used for taking a baby on a baby caretaker's back.

Fourth, the conventional baby carrier requires that the legs of the baby are widened to enable a baby caretaker to insert the baby into a saddle pants portion. Using the baby carrier according to the present invention, a baby caretaker easily carries the shoulder straps of the baby carrier on his or her shoulder after a baby is laid or positioned on the baby wrapper at the state where the baby wrapper is unfolded, with a result that the baby can be easily taken on the baby caretaker's back at a time.

Finally, the baby carrier according to the present invention can be applied depending upon the body shape of a baby by adjusting adjustment straps.

What is claimed is:

1. A baby carrier comprising:
a baby wrapper having a back supporter in which the back of a baby is supported, a bottom sheet extended from the back supporter and in which the hip of the baby contacts, and auxiliary supporters each connected to the bottom sheet, for supporting the thighs of the baby; and
shoulder straps for mutually connecting the back supporter and the auxiliary supporters and hooking the mutually connected straps on the shoulders of a baby caretaker.

2. The baby carrier of claim 1, wherein the sheet of said baby wrapper forms a folding line with respect to the bottom sheet, in which a border is externally formed by the folding line at the state where the sheet is folded.

3. The baby carrier of claim 1, further comprising a support in which connection belts for connecting the shoulder straps mutually are formed in the middle of the shoulder straps, and safety belts connected to the shoulder straps are sewed around the lower-center of the baby wrapper.

4. The baby carrier of claim 1, further comprising a sack having a reception space are additionally formed in the back supporter of the baby wrapper.

5. The baby carrier of claim 2, further comprising a sack having a reception space are additionally formed in the back supporter of the baby wrapper.

6. The baby carrier of claim 3, further comprising a sack having a reception space are additionally formed in the back supporter of the baby wrapper.

7. The baby carrier of claim 1, wherein said sack comprises an auxiliary pocket.

8. The baby carrier of claim 2, wherein said sack comprises an auxiliary pocket.

9. The baby carrier of claim 3, wherein said sack comprises an auxiliary pocket.

10. The baby carrier of claim 1, wherein said auxiliary supporters are connected by gap adjustment straps so that a gap with respect to the back supporter or the bottom sheet can be adjusted.
